(19) United States
(12) Patent Application Publication
(10) Pub. No.: US 2012/0096350 A1
(43) Pub. Date: Apr. 19, 2012

(54) ELECTRONIC DEVICE

(75) Inventors: ZHENG-HAO CHU, Shenzhen City (CN); XIN-NAN WANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/015,513

(22) Filed: Jan. 27, 2011

(30) Foreign Application Priority Data
Oct. 15, 2010 (CN) 201010510377.3

(51) Int. Cl. G06F 3/041; G06F 3/01; G06F 17/00

(52) U.S. Cl. 715/702; 345/173; 345/418

(57) ABSTRACT

An electronic device includes a main display screen and a touch screen. The touch screen is used for being touched by users to define a touch track and generating an input signal corresponding to the attributes of the touch track. Programs may be activated and control functions performed in response to how a user touches the touch screen.

### BACKGROUND

1. Technical Field

The present disclosure relates to electronic devices, particularly to an electronic device having a touch screen.

2. Description of Related Art

A conventional electronic device, such as a notebook computer or an all-in-one desktop computer will include a single display. However, when the computer is off and a user wants to see selected information such as the date and/or weather conditions, they must first power up the computer to power up the display, which is an inconvenience. Additionally, to access and use any program when the computer is powered up, an input device such as a mouse or keypad must be used, which is also inconvenient, particularly when accessing frequently used programs.

Therefore, there is room for improvement in the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an isometric schematic view of an electronic device according to a first exemplary embodiment of the present disclosure.

FIG. 2 is a functional block diagram of the electronic device of FIG. 1, and the electronic device has a first control module and a second control module.

FIG. 3 is a block diagram of the second control module of FIG. 2 according to a first exemplary embodiment.

FIG. 4 is a block diagram of the second control module of FIG. 2 according to a second exemplary embodiment.

FIG. 5 is an isometric schematic view of an electronic device according to a second exemplary embodiment of the present disclosure.

### DETAILED DESCRIPTION

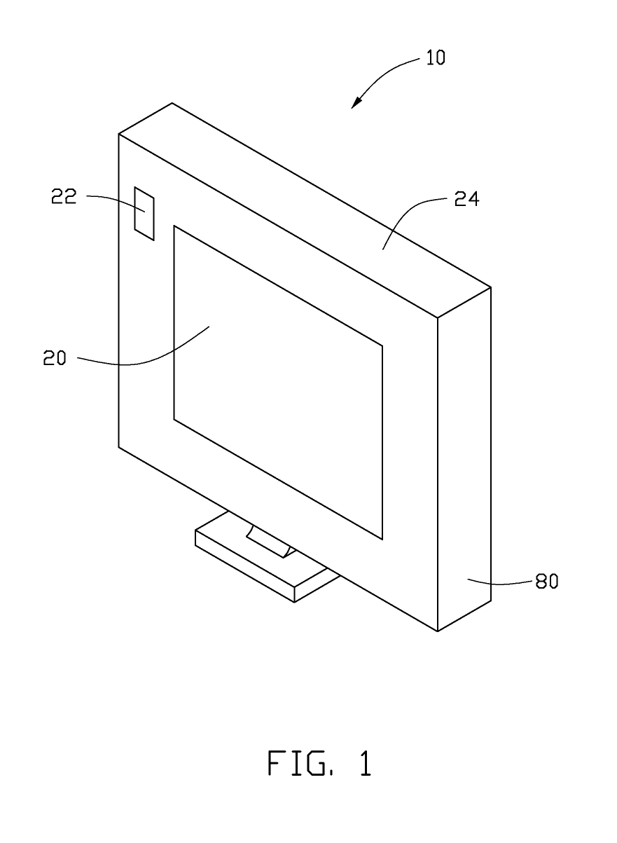

Referring to FIG. 1, an electronic device 10 includes a main screen 20, a touch screen 22, and a housing 24 for receiving the main screen 20 and the touch screen 22. The touch screen 22 and the main screen 20 are disposed on the same side of the housing 24. The main screen 20 is a conventional screen which can be applied in a notebook computer or a TV set. The touch screen 22 can function as a secondary display when the main screen 20 is off, and display selected information such as date, time, temperature etc. When the main screen 20 is on, the touch screen 22 is used to be touched by users to define a touch track thereon as a simple and convenient input device that can be programmed to open frequently used programs in response to simple touch track by users. Instead of or in addition to programs, certain control functions may be implemented in response to the touch track by users, such as volume control when a music program is operating. In the embodiment, the main screen 20 is a liquid crystal display (LCD) screen, and the touch screen 22 is a capacitive touch screen. In other embodiments, the main screen 20 may be a light emitting diode (LED) display screen, and the touch screen 22 may be a resistive touch screen.

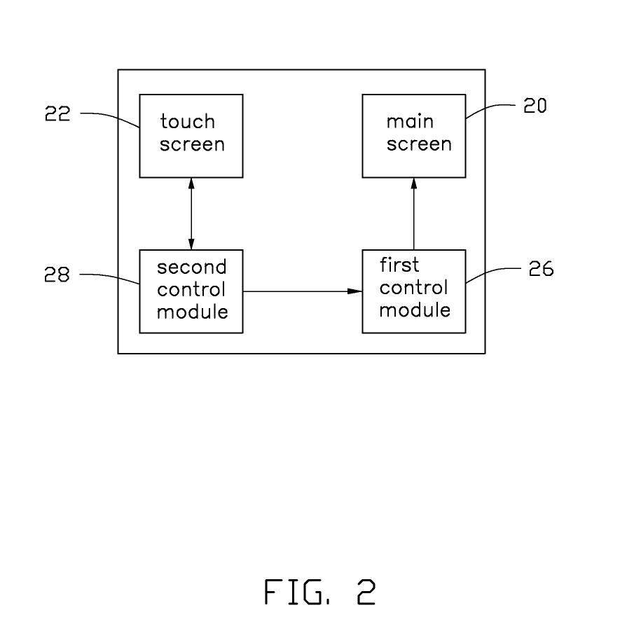

Referring to FIG. 2, the electronic device 10 further includes a first control module 26 electrically connected to the main screen 20, and a second control module 28 electrically connected to the touch screen 22 and the first control module 26. The first control module 26 is used to control the main screen 20. The second control module 28 is used for analyzing the touch track by users.

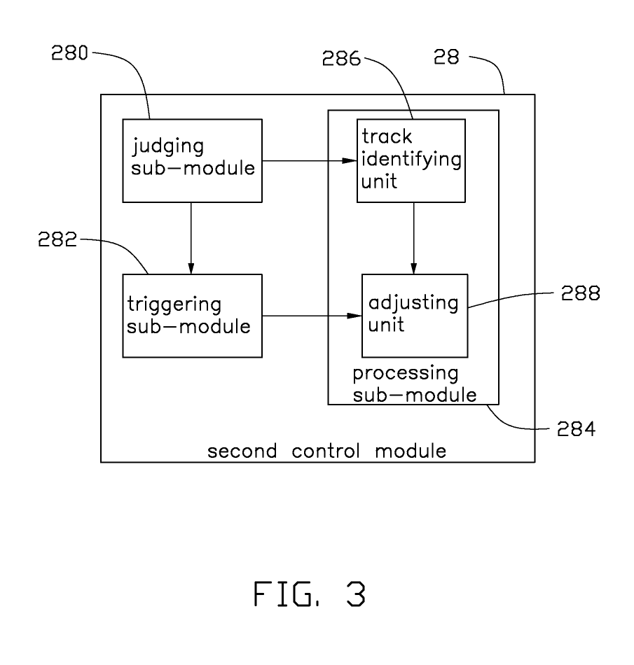

Referring to FIG. 3, in one embodiment, the second control module 28 includes a judging sub-module 280, a triggering sub-module 282, and a processing sub-module 284.

The judging sub-module 280 is used to determine whether the touch track forms a sliding touch. If the touch track does not form a sliding touch, the input signal from the touch screen 22 is taken as a first input signal, in other words the user has touched only a point on the touch screen 22 without sliding in a direction from the initial point touched, and the judging sub-module 280 outputs a first judging signal. If the touch track forms a sliding touch, the judging sub-module 280 outputs a second judging signal indicating the touch track forms a sliding touch. Specifically, the first judging signal and the second judging signal may be respectively a high level signal recognized to be a logical “1” and a low level signal recognized as logical “0”.

The triggering sub-module 282 is electrically connected to the judging sub-module 280. The triggering sub-module 282 is used for triggering or closing an application, previously associated with the first judging signal. In the embodiment, the application is a word-processing program of the electronic device 10. In other embodiments, the application may be other frequently used programs such as a music player or a calculator of the electronic device 10.

The processing sub-module 284 is electrically connected to the triggering sub-module 282, the touch screen 22, and the first control module 26. The processing sub-module 284 is used to determine the direction of the touch track that has been determined to form a sliding touch after receiving the second judging signal. The processing sub-module 284 can perform a predetermined control function in response to the direction of the sliding touch, eg. adjusting a parameter of the main screen 20. For example, if the direction of the sliding touch extends from left to right, the processing sub-module 284 could be configured to increase the brightness of the main screen 20. If the direction of the sliding touch extends from right to left, the processing sub-module 284 could be configured to decrease the brightness of the main screen 20.

The processing sub-module 284 includes a track identifying unit 286 and an adjusting unit 288. The track identifying unit 286 is electrically connected to the judging sub-module 280 and the touch screen 22. In the embodiment, the track identifying unit 286 is triggered when receiving the second judging signal. The track identifying unit 286 determines the direction of the sliding touch to discern whether the input signal from the touch screen 22 corresponds to a second input signal or a third input signal. In detail, when users touch a point of the touch screen 22, the capacitance corresponding to the point changes immediately, which causes the current corresponding to the first point to change immediately, therefore, the track identifying unit 286 can precisely capture the coordinates of all points contacted by a sliding touch corresponding to the changes in current. The track identifying unit 286 figures out the direction of the sliding touch by comparing the coordinates of the first point touched and the final point touched at the end of the sliding touch (the touch track). If the direction of the sliding touch is, for example, from left to right, the tracking identifying unit 286 associates the input signal with the second input signal and thus outputs a first direction signal. If direction of the sliding touch is, for example, from right to left, the track identifying unit 286 associates with the input signal with the third input signal and thus outputs a second direction signal.

The adjusting unit 288 is electrically connected to the track identifying unit 286 and the first control module 26. In this embodiment, the adjusting unit 288 responds to the first direction signal or the second direction signal by adjusting a predetermined parameter of the main screen 20 or an open program. In the embodiment, the parameter refers to the brightness of the main screen 20. When receiving the first adjusting signal, the adjusting unit 288 increases the brightness of the main screen 20, otherwise the adjusting unit 288 decreases the brightness of the main screen 20. The adjusting unit 288 can adjust the brightness of the main screen 20 by adjusting the power of the back-lighting source of the main screen 20.

However, it should be understood that the parameter of the electronic device is not limited to this embodiment. In other alternative embodiments, the parameter can refer to the contrast of main screen 20. For example, when the track identifying unit 286 determines that the direction of the sliding touch extends from left to right, the adjusting unit 288 increases contrast of the main screen 20, otherwise the adjusting unit 288 decrease contrast of the main screen 20. Also, the direction of the sliding touch is not limited to the embodiment too. Similarly, the direction of the sliding touch can extend from top to bottom or from bottom to top too.

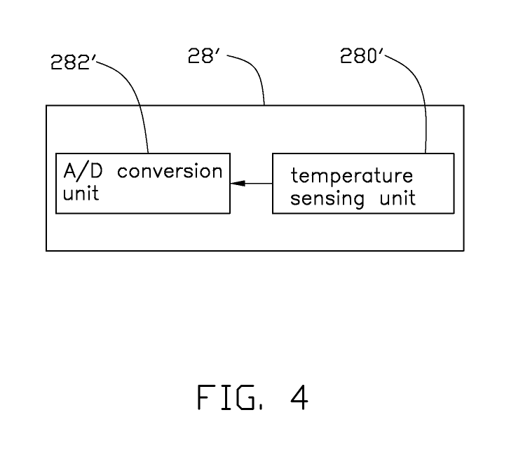

Referring to FIG. 4, in other embodiments, a second control module 28′ can be used for capturing information and the touch screen 22 can be used for displaying that information. The information may refer to the ambient conditions. As shown in FIG. 4, in the embodiment, the information refers to ambient temperature. The second control module 28′ includes a temperature sensing unit 280′ and an analog-digital (A/D) conversion unit 282′. The temperature sensing unit 280′ is used for measuring ambient temperature as an analog signal. The A/D conversion unit 282′ is electrically connected to the temperature sensing unit 280′ and the touch screen 22 for digitally converting the analog signal so that the ambient temperature can be displayed on the touch screen 22. Moreover, the second control module 28′ still can include a power supply unit for meeting power requirement of the touch screen 22. Therefore, the touch screen 22 can still display the needed information even while the main screen 20 is off or in a standby mode.

It should be understood that what is displayed on the touch screen 22 may duplicate what is displayed on the main screen 20. For example, when the main screen 20 displays a picture, the touch screen displays the same picture.

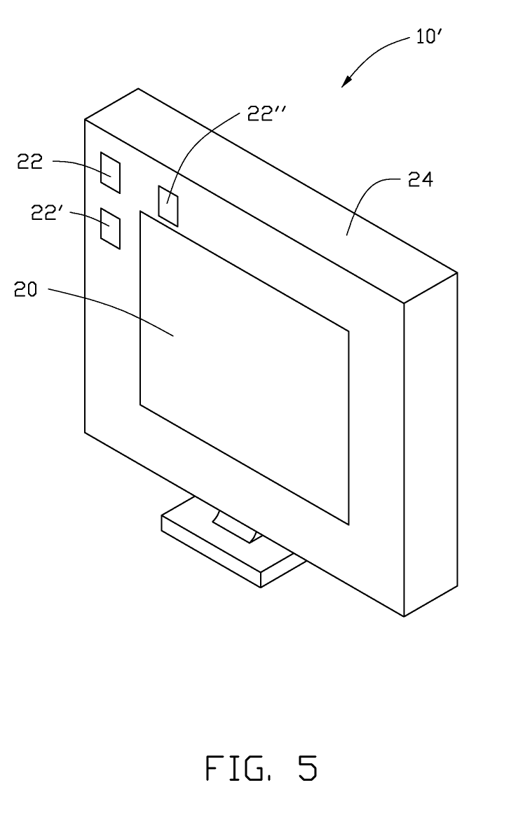

It should be understood that there is no limit to the number of the touch screens 22 applied. As shown in FIG. 5, an electronic device 10′ can include other touch screens such as a second touch screen 22′ and a third touch screen 22″. The plurality of touch screens can be used for triggering a plurality of applications, adjusting different parameters, or displaying different kinds of information. For example, the touch screen 22 can be used for triggering the word processing program, the first touch screen 22′ can be used for triggering the music playing program, and the second touch screen 22″ can be used for triggering a game program of the electronic device 10. It is understood that the first touch screen 22′ and the second touch screen 22″ can receive input simultaneously for triggering other applications of the electronic device 10′.

As described above, with the touch screen 22 disposed on the housing 24 of display 20, and with the second control module 28, users can trigger at least one application of the electronic device 10 by a simple touch to the touch screen 22, which is more convenient than typical input devices, and adjust at least one parameter of the electronic device 10 by dragging their finger or a touch pen across the touch screen 22. Moreover, since the touch screen 22 is disposed on the housing 24, the touch screen 22 can display information without interfering with the displaying function of the main screen 20.

It is to be understood, however, that even though information and advantages of the present embodiments have been set forth in the foregoing description, together with details of the structures and functions of the present embodiments, the disclosure is illustrative only; and that changes may be made in detail, especially in matters of shape, size, and arrangement of parts within the principles of the present embodiments to the full extent indicated by the broad general meaning of the terms in which the appended claims are expressed.

1. An electronic device, comprising:
a main screen for displaying information; and
a touch screen used for being touched by users to form a touch track and generating input signals corresponding to the attributes of the touch track;
wherein the input signals being selected from a group comprising a first input signal, a second input signal and a third input signal; and
wherein an application of the electronic device is capable of being activated when the first input signal is generated; a parameter of the electronic device is capable of being adjusted in a first manner when the second input signal is generated; and the parameter of the electronic device is capable of being adjusted in a second manner different from the first manner when the third input signal is generated.

2. The electronic device as claimed in claim 1, wherein the electronic device further comprises a first control module and a second control module; the first control module is electrically connected to the main screen for controlling the main screen, the second control module is electrically connected to the touch screen and the first control module for analyzing the attribute of the touch track.

3. The electronic device as claimed in claim 2, wherein the second control module comprises a judging sub-module and a triggering sub-module, the judging sub-module is used for judging whether the touch track forms a point touch or a sliding touch, if the touch track forms a point touch, the touch screen inputs the first input signal, and the judging sub-module outputs a first judging signal; the triggering sub-module is used for receiving the first judging signal and activating an application of the electronic device.

4. The electronic device as claimed in claim 3, wherein the application refers to a word processing program of the electronic device.

5. The electronic device as claimed in claim 3, wherein the application refers to a music player of the electronic device.

6. The electronic device as claimed in claim 3, wherein the judging sub-module outputs a second judging signal if the touch track forms a sliding touch; the electronic device further comprises a processing sub-module for receiving the second judging signal and determining the direction of the sliding touch to adjust a parameter of the main screen.

7. The electronic device as claimed in claim 6, wherein the processing sub-module comprises a track identifying unit and an adjusting unit, the track identifying unit is electrically connected to the judging sub-module and the touch screen for determining the direction of the sliding touch and outputting different direction signals in response to the direction of the sliding touch; the adjusting unit is electrically connected to the track identifying unit and the first control module for adjusting the parameter of the main screen in response to the direction signals.

8. The electronic device as claimed in claim 7, wherein the parameter of the main screen refers to the contrast of the main screen.

9. The electronic device as claimed in claim 7, wherein the parameter of the main screen refers to the brightness of the main screen.

10. The electronic device as claimed in claim 9, wherein the different direction signals comprises a first direction signal and a second direction signal; if the direction of the sliding touch is from left to right, the touch screen input the second input signal, and the track identifying unit outputs the first direction signal, and the brightness of the main screen is being adjusted in the first manner to be increased; if the direction of the sliding touch is from right to left, the touch screen input the third input signal, and the track identifying unit outputs the second direction signal, and the brightness of main screen is being adjusted in the second manner to be decreased.

11. An electronic device, comprising:
a main screen for displaying first information; and
a touch screen for displaying second information;
wherein the first information is the same as the second information or different from the second information.

12. The electronic device as claimed in claim 11, wherein the second information is different from the first information.

13. The electronic device as claimed as claim 12, wherein the second information refers to ambient conditions.

14. The electronic device as claimed in claim 13, wherein the electronic device further comprises a first control module and a second control module, the first control module is electrically connected to main screen for controlling the main screen to display the first information, the second control module is electrically connected to the touch screen and the first control module for capturing information about ambient conditions.

15. The electronic device as claimed as claim 14, wherein the second information is the ambient temperature; and the second control module comprises a temperature sensing unit and a A/D conversion unit, the temperature sensing unit is used to measure the ambient temperature defined as an analog signal, the A/D convector is used for digitally converting the analog signal.

16. The electronic device as claimed in claim 15, wherein the second control module further comprises a power supply unit for meeting power requirement of the touch screen.

17. An electronic device, comprising:
a main screen for displaying corresponding images or information;
a plurality of touch screens; and
a housing for holding the main screen and the touch screens; the main screen and the touch screens being disposed on the same side of the housing.

18. The electronic device as claimed as in claim 17, wherein the plurality of touch screens are used for activating different applications of the electronic device corresponding to users' operations.

19. The electronic device as claimed as in claim 17, wherein the plurality of the touch screens are used for adjusting different parameters of electronic device.
